(19) United States
(12) Patent Application Publication
(10) Pub. No.: US 2018/0003823 A1
(43) Pub. Date: Jan. 4, 2018

(54) ROTARY TYPE DISTANCE SENSING DEVICE

(71) Applicant: Jason Yan, New Taipei City (TW)

(72) Inventor: Jason Yan, New Taipei City (TW)

(21) Appl. No.: 15/582,553

(22) Filed: Apr. 28, 2017

(30) Foreign Application Priority Data
Jun. 30, 2016 (TW) 105120688
Nov. 4, 2016 (TW) 105135822

(51) Int. Cl. G01S 17/08; A47L 11/40; G01S 7/481; G05D 1/02

(52) U.S. Cl. CPC G01S 17/08; G01S 7/4811; A47L 11/4011; G05D 1/024; G05D 2201/0203; G05D 1/0219

(57) ABSTRACT

The present invention discloses a rotary type distance sensing device is disclosed, wherein the rotary type distance sensing device comprises a driver to drive the linking structure to move and to enable the rotating mount to rotate; a control module fixed to rotating mount transmitting a measurement signal through a signal transmitter and receiving the reflected measurement signal through a signal receiver to obtain an environmental status data ; the control module analyzing the reflected measurement signal and transmitting the reflected measurement signal though a wireless transmitter, or the control module directly transmitting the reflected measurement signal along with data regarding the transmitted measurement signal through the wireless transmitter, thereby preventing a signal wire from being wound too tightly and tangled, and also preventing a slip ring structure from being worn out after long term use, and thus assuring the signal transmission quality.

### INCORPORATION BY REFERENCE

The present application is based on, and claims priority from, Taiwan Application Serial Number 105120688, filed Jun. 30, 2016, and Taiwan Application Serial Number 105135822, filed Nov. 4, 2016, the disclosure of which is hereby incorporated by reference herein in its entirety.

### BACKGROUND OF THE INVENTION

### 1. Field of the Invention

The present invention relates to a range detecting device of an automatic sweeping robot, and more particularly, to a rotary type distance sensing device which can prevent the internal signal wire from being wound too tightly and tangled, and can also prevent the slip ring structure from being worn out after long term use.

### 2. Description of the Prior Art

As the automatic sweeping robot technology becomes mature, related products are more popular in the households to provide automatic sweeping services for users.

In order to effectively get environmental cleaning job done, presently an automatic sweeping robot uses a range detecting device (such as a distance detection device) to detect the spatial layout, set up the cleaning path of the automatic sweeping robot based on detected data, and record the cleaned area.

A prior art range detecting device such as that disclosed in US patent application US2010/0030380 employs a distance measuring device which can rotate 360 degrees to detect the environment and transmits the detected data to the control system of the automatic sweeping robot for processing. However, when the distance measuring device is rotating, its signal wire could break to reduce the signal transmission quality when it is wound too tightly and tangled. In this case, the operation of the automatic sweeping robot could be affected and often causes service downgrade.

Therefore, it is necessary to provide a range detecting device which can rotate 360 degrees and also prevents the internal signal wire from being wound too tightly and tangled to affect the signal transmission quality.

### SUMMARY OF THE INVENTION

In order to solve the problems described above, it is an object of the present invention to provide a range detecting device which can rotate 360 degrees and prevent the signal wire from being wound too tightly and tangled.

In order to achieve the above object, the present invention provides a rotary type distance sensing device, which mainly comprises a fixing base, a rotating mount, and a control module. The fixing base comprises a via and a positioning ring disposed coaxially, with the positioning ring being disposed around an outer rim of the via. The axis of the rotating mount comprises a positioning hole pivotally connected with the outer rim of the positioning ring, wherein the positioning hole is provided for the rotating mount to be pivotally connected to the fixing base. The control module is fixed on the rotating mount.

The outer rim of the positioning ring is surrounded by a bearing pivotally connected with the rotating mount.

The fixing base comprises a driver disposed at one side of the bottom of the fixing base, wherein the driver is used for driving a linking structure to move and to enable the rotating mount to rotate.

The driver can be a motor or any other power transmission devices.

The linking structure can be implemented by a pulley structure, a gear structure, or any other structure which can be driven by the driver to move and to enable the rotating mount to rotate.

The fixing base comprises a through hole disposed with respect to the drive shaft of the motor for the drive shaft to go through to be connected with a pulley. The axis of the rotating mount comprises a positioning hole pivotally connected to the bearing. A belt is disposed around the outer rims of the rotating mount and the pulley.

The via of the fixing base is disposed with a wireless receiver coupled with the control module of the automatic sweeping robot.

The control module comprises at least one signal transmitter for transmitting a measurement signal, at least one signal receiver for receiving the reflected measurement signal, and a wireless transmitter being disposed below the control module and going through the via; the control module analyzing the reflected measurement signal received by the signal receiver and using the wireless transmitter to transmit the analyzed data to the wireless receiver.

The control module comprises two power receiving structures disposed at the bottom thereof. The power receiving structures comprise at least two concentric conductive rings coaxially disposed with the rotating mount.

A power transmitting structure is disposed between the positioning ring and the via, the power transmitting structure comprises a positive electrode conducting structure and a negative electrode conducting structure fixedly disposed between the positioning ring and the via. The positive electrode conducting structure and the negative electrode conducting structure are disposed coaxially with the power receiving structure. The positive electrode conducting structure and the negative electrode conducting structure are each cascaded with at least two conductors through a power transmission wire. The conductors of the positive electrode conducting structure are in contact with the power receiving structure respectively. The conductors of the negative electrode conducting structure are in contact with the power receiving structure respectively. The conductors comprise arc-shaped contact surfaces being in contact with the power receiving structure.

### BRIEF DESCRIPTION OF THE DRAWINGS

FIG. 1 illustrates a 3D view of a rotary type distance sensing device of the present invention;

FIG. 2 illustrates a partially 3D view of the rotary type distance sensing device of the present invention;

FIG. 3 illustrates a partially perspective view of the rotary type distance sensing device shown in FIG. 2;

FIG. 4 further illustrates a partially perspective view of the rotary type distance sensing device shown in FIG. 3;

FIG. 5 further illustrates a partially perspective view of the rotary type distance sensing device shown in FIG. 4;

FIG. 6 illustrates a 3D view of a rotary type distance sensing device of the present invention from another view angle;

FIG. 7 illustrates a bottom view of a control module of the present invention;

FIG. 8 illustrates views of a positive electrode conducting structure and a negative electrode conducting structure of the present invention;

FIG. 9 illustrates a bottom view of a relative position of the control module with respect to the positive electrode conducting structure and the negative electrode conducting structure;

FIG. 10 illustrates a cross sectional view of a relative position of the fixing base with respect to the wireless transmitter and the wireless receiver;

FIG. 11 illustrates a partially 3D view of the rotary type distance sensing device in another embodiment of the present invention;

FIG. 12 illustrates a partially perspective view of the rotary type distance sensing device shown in FIG. 11;

FIG. 13 further illustrates a partially perspective view of the rotary type distance sensing device shown in FIG. 12; and

FIG. 14 further illustrates a partially perspective view of the rotary type distance sensing device shown in FIG. 13.

### REFERENCE NUMERALS

1 fixing base

11 via

12 positioning ring

13 through hole

14 bearing

15 wireless receiver

2 rotating mount

21 positioning hole

22 penetrating hole

3 control module

31 wireless transmitter

32 first concentric conductive ring

33 second concentric conductive ring

4 conducting structure positive electrode conducting structure

41 first power transmission wire

42 first conductor

43 second conductor

5 conducting structure negative electrode conducting structure

51 second power transmission wire

52 third conductor

53 fourth conductor

6 motor

61 pulley

62 belt

7 signal transmitter

8 signal receiver

9 conducting structure

91 power receiving structure

911 transmission unit

912 annular conductor

913 inner hole

92 power transmitting structure

921 positive electrode brush

922 negative electrode brush

923 spring plate

### DETAILED DESCRIPTION OF THE PREFERRED EMBODIMENT

The advantages and innovative features of the invention will become more apparent from the following detailed description when taken in conjunction with the accompanying drawings.

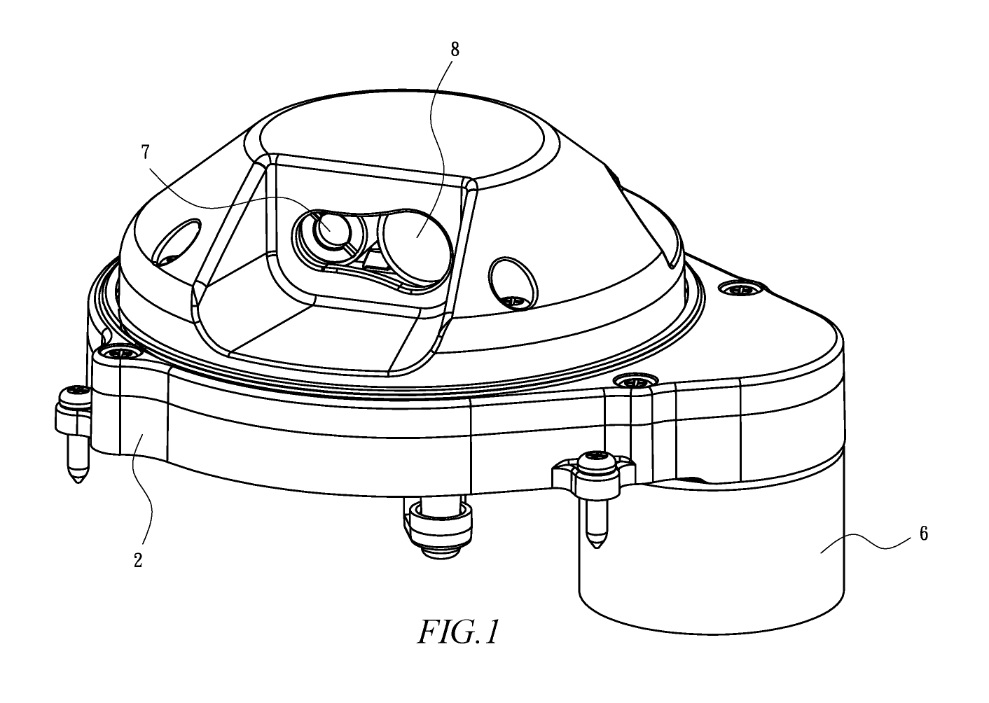

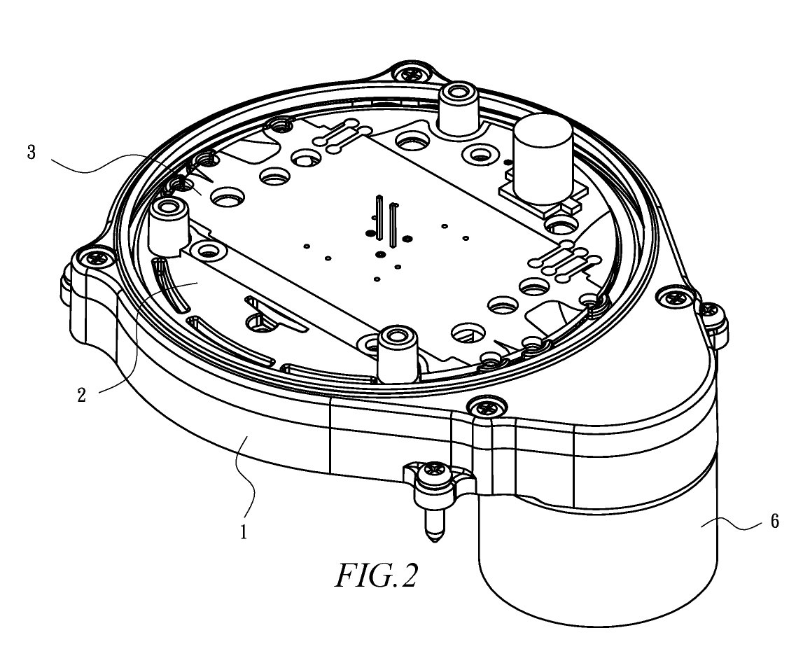

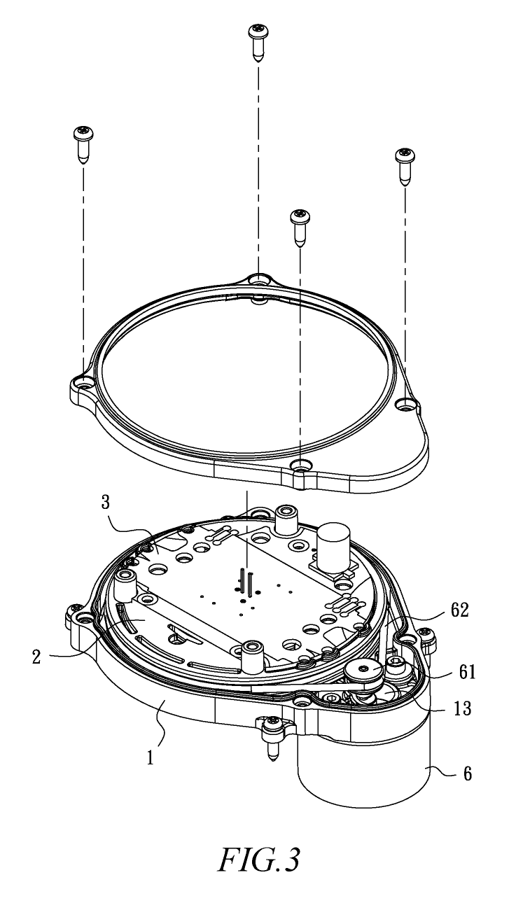

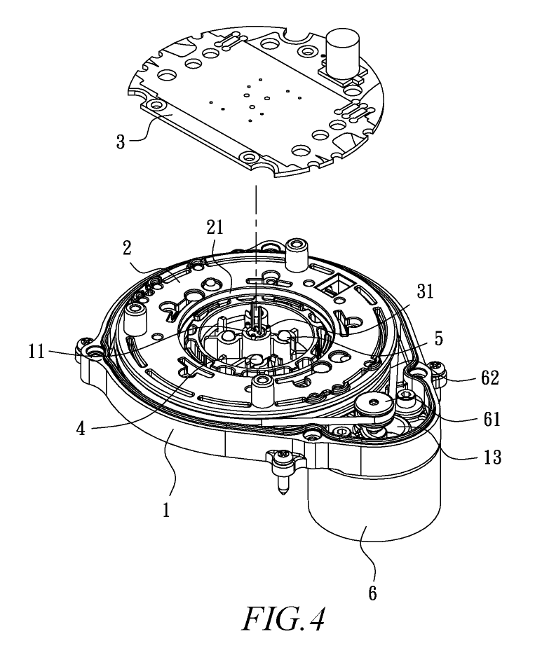

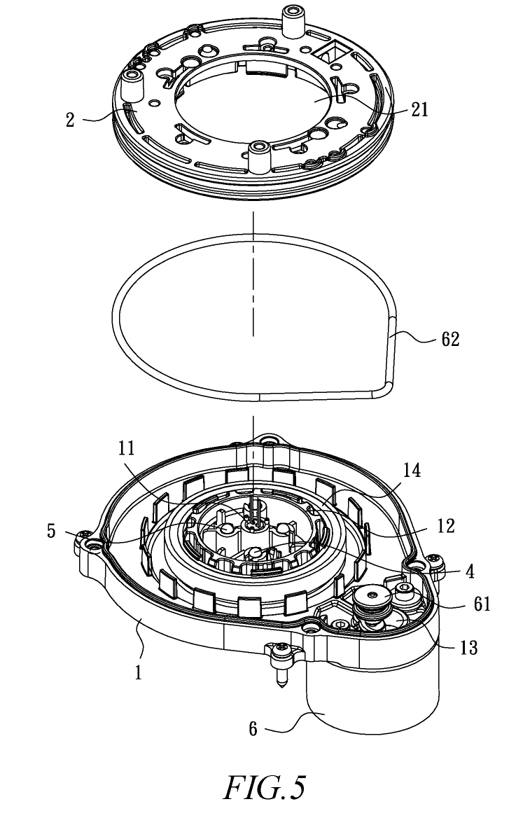

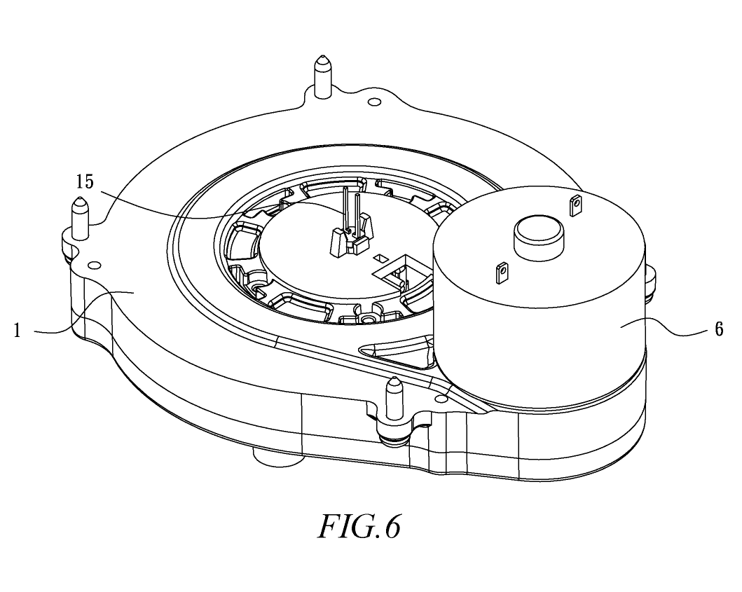

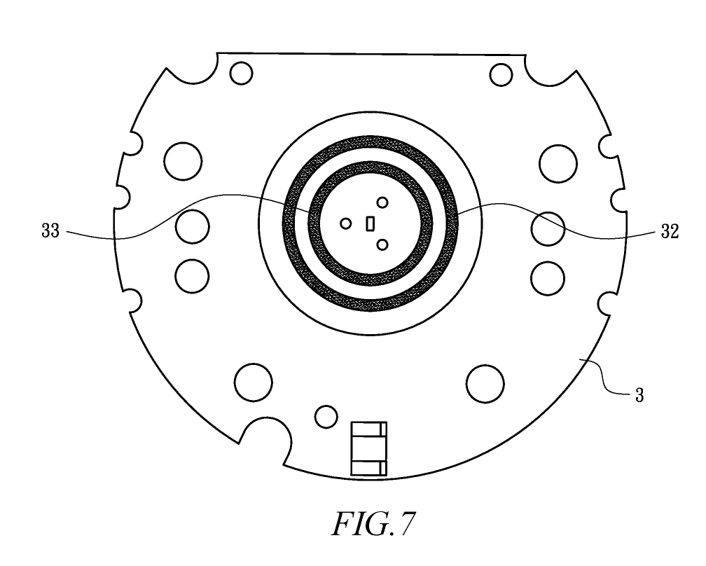

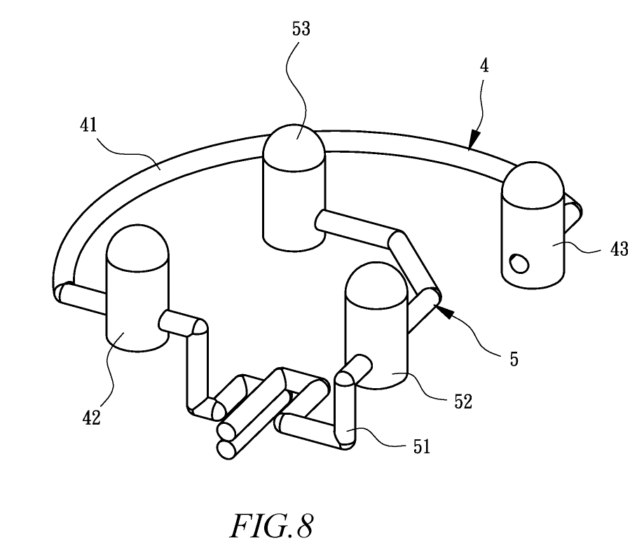

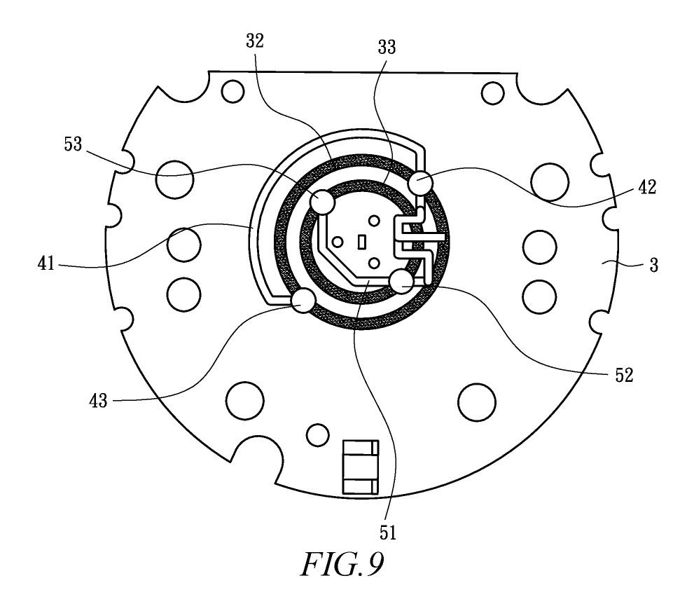

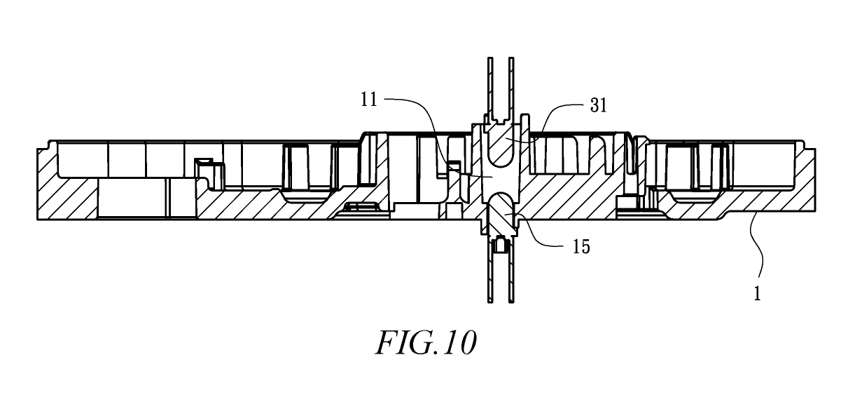

Please refer to FIG. 1 to FIG. 10, a rotary type distance sensing device of the present invention mainly comprises a fixing base 1, a rotating mount 2, and a control module 3; the fixing base 1 comprises a via 11 being disposed at the center and penetrating through the fixing base 1, and a positioning ring 12 disposed around the outer rim of the via 11. The via 11 contains a wireless receiver 15 coupled with the control module (not shown in figure) of the automatic sweeping robot. A bearing 14 is disposed around the outer rim of the positioning ring 12. The fixing base 1 comprises a motor 6 disposed at one side of the bottom thereof, the fixing base 1 also comprises a through hole 13 disposed with respect to the drive shaft of the motor for the drive shaft to go through to be connected with a pulley 61. The axis of the rotating mount 2 comprises a positioning hole 21 pivotally connected with the earing 14. The rotating mount 2 is driven by a belt 62 to move along with the pulley 61. The control module 3 is fixed on the rotating mount 2, the control module 3 comprises at least one signal transmitter 7, at least one signal receiver 8, and a wireless transmitter 31, wherein the control module 3 is a controller circuit board, the signal transmitter 7 and the signal receiver 8 are disposed on the control module 3, and the wireless transmitter 31 is disposed below the control module 3 and goes through the via 11. Two power receiving structures are disposed at the bottom of the control module 3 and correspond to the positioning hole 21 of the rotating mount 2, the power receiving structures comprises a first concentric metal conductive ring 32 and a second concentric metal conductive ring 33 coaxially disposed with the positioning hole 21.

Furthermore, a positive electrode conducting structure 4 and a negative electrode conducting structure 5 are disposed between the via 11 and the positioning ring 12 of the fixing base 1, the positive electrode conducting structure 4 is connected with the positive electrode of a power supply (not shown in figure) through a first power transmission wire 41, the negative electrode conducting structure 5 is connected with the negative electrode of the power supply through a second power transmission wire 51, wherein the first power transmission wire 41 is cascaded with a first conductor 42 and a second conductor 43, the second power transmission wire 51 is cascaded with a third conductor 52 and a fourth conductor 53, the top surfaces of the first conductor 42 and the second conductor 43 are in contact with the first concentric conductive ring 32, the top surfaces of the third conductor 52 and the fourth conductor 53 are in contact with the second concentric conductive ring 33; wherein the top surfaces of the first conductor 42, the second conductor 43, the third conductor 52, and the fourth conductor 53 are arc-shaped surfaces. The rotary type distance sensing device of the present invention uses the first power transmission wire 41 to transmit the power signal from the positive electrode to the first conductor 42 and the second conductor 43 cascaded with the first power transmission wire 41, and uses the second power transmission wire 51 to transmit the power signal from the negative electrode to the third conductor 52 and the fourth conductor 53 cascaded with the second power transmission wire 51. Then power receiving structure receives the power signals from the conductors to power the signal transmitter 7, the signal receiver 8, and the wireless transmitter 31 of the control module 3.

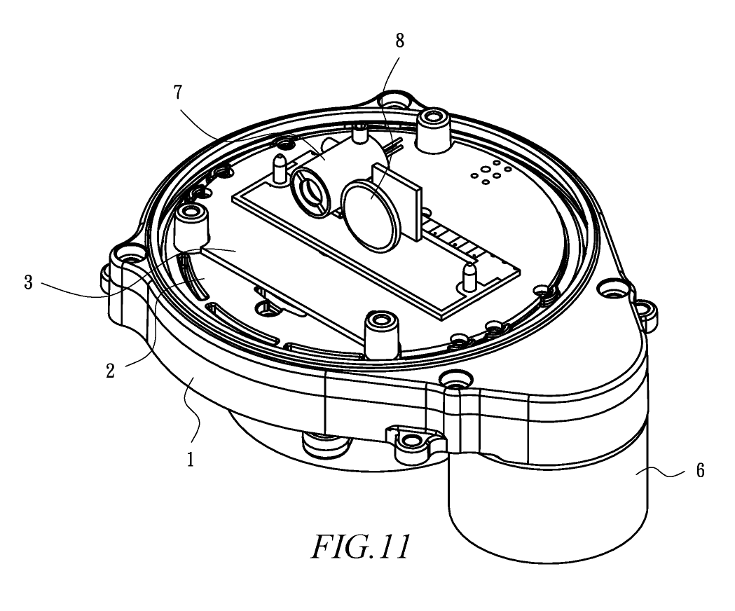

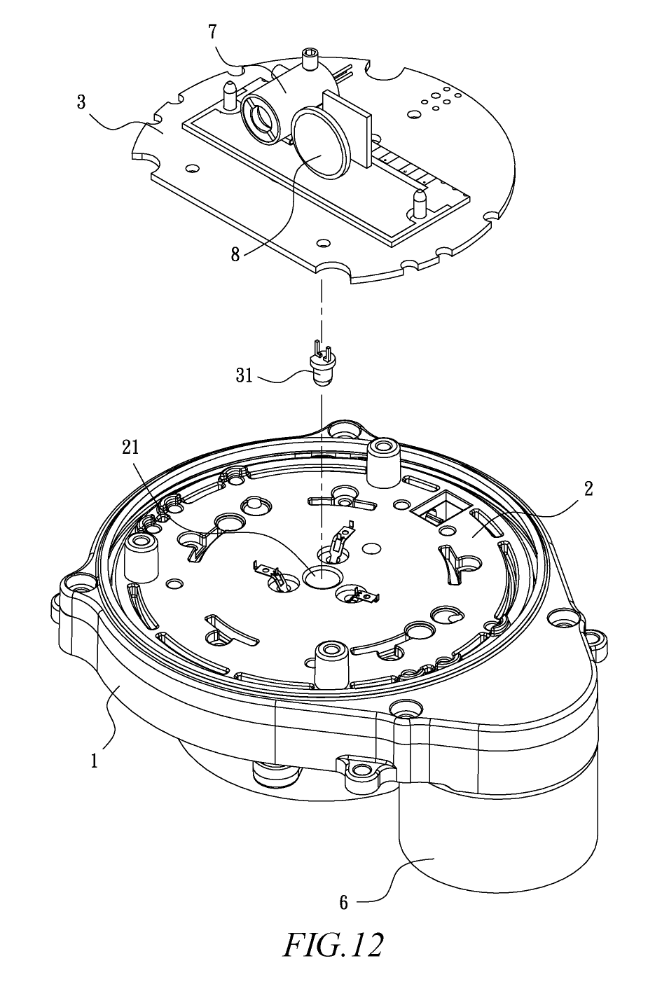

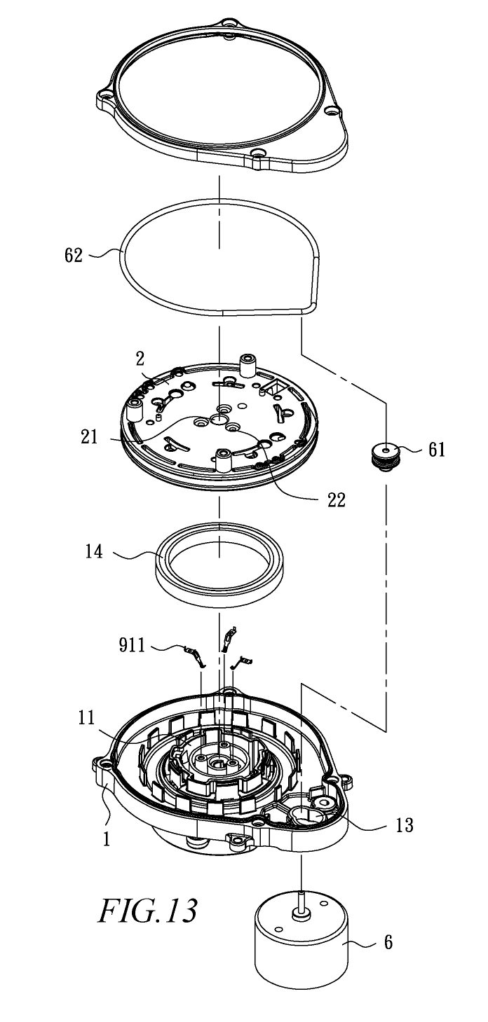

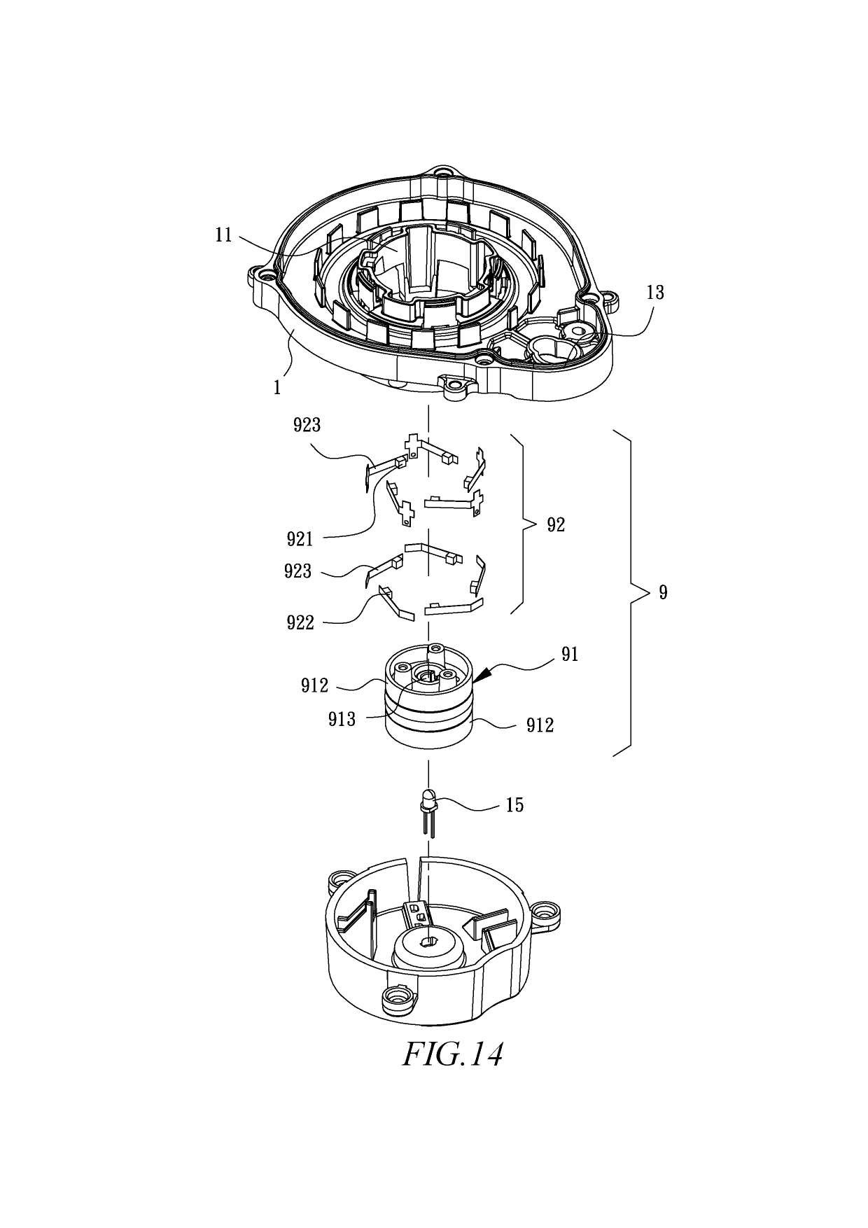

Besides, please refer to FIG. 1 and FIG. 11 to FIG. 14 for another embodiment of the rotary type distance sensing device of the present invention. In the embodiment, the rotary type distance sensing device comprises a fixing base 1, a rotating mount 2, a control module 3, and a conducting structure 9, the fixing base 1 comprising a via 11 penetrating through the center of the fixing base 1 and a bearing 14 disposed around an upper outer rim of the via 11, the fixing base 1 comprising a motor 6 disposed at a side of the bottom thereof, the fixing base 1 also comprising a through hole 13 corresponding to the driving shaft of the motor 6, thereby allowing the driving shaft to go through to be connected with a pulley 61.

The rotating mount 2 is pivotally connected with the bearing 14, the axis of the rotating mount 2 comprises a positioning hole 21 and at least one penetrating hole disposed around the positioning hole 21 to penetrate the rotating mount 2; the rotating mount 2 is driven by a belt 62 to move along with the pulley 61. The control module 3 is fixed on the rotating mount 2 and comprises at least one signal transmitter 7, at least one signal receiver 8, and a wireless transmitter 31, the control module 3 is a controller circuit board having the signal transmitter 7 and the signal receiver 8 disposed thereon, wherein the wireless transmitter 31 is disposed under the control module 3 and goes through the positioning hole 21.

The conductive structure 9 comprises a power receiving structure 91 and a plurality of power transmitting structures 92, wherein the power receiving structure 91 comprises at least one transmission unit 911 corresponding to the penetrating hole 22 of the rotating mount 2, at least two annular conductors 912 disposed around the outer rim of the power receiving structure 91, and an inner hole 913, wherein the inner hole 913 is disposed at the position of the power receiving structure 91 corresponding to the positioning hole 21 of the rotating mount, and the inner hole 913 goes through the top and bottom of the power receiving structure 91; the inner hole 913 comprises a wireless receiver 15 penetrating through the bottom of the fixing base 1 to be disposed inside the inner hole 913.

The transmission unit 911 goes through the penetrating hole 22 of the rotating mount 2 to be connected with the control module 3. The plurality of power transmitting structures 92 comprises at least one positive electrode brush 921 and at least one negative electrode brush 922 connected with a power supplying device (not shown in figure), wherein the positive electrode brush 921 and the negative electrode brush 922 are each fixed (by gluing, plugging or locking) at the inner wall of the via 11 of the fixing base 1 through a spring plate 923, and the positive electrode brush 921 and the negative electrode brush 922 are in contact with the at least two annular conductors 912 respectively, thereby transmitting the power of the power supplying device to the control module 3 to power the signal transmitter 7, the signal receiver 8, and the wireless transmitter 31 of the control module 3.

When the rotary type distance sensing device is operating, the motor 6 drives the pulley 61 to move, which in turn drives the rotating mount 2 to rotate with respect to the bearing 14 (as the axis) through the belt 62. At this time the control module 3 disposed fixedly on the rotating mount 2 transmits a measurement signal through the signal transmitter 7 and then receives the reflected measurement signal through the signal receiver 8 to obtain an environmental status data, then the control module 3 analyzes the reflected measurement signal (such as obtaining a difference in phase, time, or frequency between the measurement signal transmitted by the signal transmitter 7 and the reflected measurement signal received by the signal receiver 8) and uses the wireless transmitter 31 to wirelessly transmit the analyzed measurement signal to the wireless receiver 15 coupled with the control module of the automatic sweeping robot, thereby allowing the control module of the automatic sweeping robot to set up the cleaning path of the automatic sweeping robot based on the analyzed measurement signal, and to record the cleaned area.

As described above, the present invention discloses a rotary type distance sensing device, while compared with prior art range detecting technique employed in the automatic sweeping robot, the present invention is advantageous in that:
1. The present invention uses the signal receiver to receive the reflected measurement signal, and the control module to analyze the reflected measurement signal and then the wireless transmitter to wirelessly transmit the analyzed measurement signal to the wireless receiver coupled with the control module of the automatic sweeping robot, thereby allowing he automatic sweeping robot to set up the cleaning path of the automatic sweeping robot based on the analyzed measurement signal, and to record the cleaned area. Therefore, the present invention transmits signals wirelessly to eliminate the problem associated with prior art when a signal wire is wound too tightly and tangled, and also prevents a slip ring structure from being worn out after long term use, in other words, the signal transmission quality is assured.
2. In the present invention, the wireless transmitter goes through the via of the fixing base, and the wireless receiver is disposed inside the via of the fixing base. Therefore, the measurement signal is transmitted directly inside the via 11 and will not be affected by other signals.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A rotary type distance sensing device, comprising:
a fixing base comprising a via and a positioning ring disposed coaxially, wherein the positioning ring is disposed around an outer rim of the via;
a rotating mount pivotally connected to the fixing base;
a linking structure driven by a driver to move and to enable the rotating mount to rotate;
a control module disposed on the rotating mount, wherein the control module comprises at least one signal transmitter for transmitting a measurement signal and at least one signal receiver for receiving the reflected measurement signal to obtain an environmental status data and to calculate a distance.

2. The rotary type distance sensing device as claimed in claim 1, wherein the control module is disposed with a wireless transmitter at the bottom thereof; the wireless transmitter goes through the via of the fixing base to transmit the reflected measurement signal received by the signal transmitter to a wireless receiver disposed in the via.

3. The rotary type distance sensing device as claimed in claim 1, wherein the outer rim of the positioning ring is surrounded by a bearing pivotally connected with a positioning hole disposed at an axis of the rotating mount.

4. The rotary type distance sensing device as claimed in claim 1, wherein the linking structure can be implemented by a pulley structure, a gear structure, or any other structure which can be driven by the driver to move and to enable the rotating mount to rotate.

5. The rotary type distance sensing device as claimed in claim 1 further comprising a conductive structure having a power transmitting structure and a power receiving structure, wherein the power transmitting structure is disposed between the positioning ring and the via and is connected with a power supplying device to provide power; the power receiving structure is disposed on the control module to receive the power provided by the power transmitting structure and to power the control module.

6. The rotary type distance sensing device as claimed in claim 5, wherein the power transmitting structure comprises a positive electrode conducting structure and a negative electrode conducting structure, the positive electrode conducting structure and the negative electrode conducting structure are each cascaded with at least two conductors through a power transmission wire to be connected with the power receiving structure.

7. The rotary type distance sensing device as claimed in claim 5, wherein the power receiving structure comprises at least two concentric conductive rings.

8. The rotary type distance sensing device as claimed in claim 6, wherein the conductors comprise arc-shaped contact surfaces being in contact with the power receiving structure.

9. A rotary type distance sensing device, comprising:
a fixing base comprising a via penetrating through the bottom thereof and a positioning ring disposed around an upper outer rim of the via;
a rotating mount pivotally connected to the fixing base;
a linking structure driven by a driver to move and to enable the rotating mount to rotate;
a control module disposed on the rotating mount, wherein the control module comprises at least one signal transmitter for transmitting a measurement signal and at least one signal receiver for receiving the reflected measurement signal to obtain an environmental status data and to calculate a distance.

10. The rotary type distance sensing device as claimed in claim 1, wherein an axis of the rotating mount comprises a positioning hole, the control module is disposed with a wireless transmitter at the bottom thereof; the wireless transmitter goes through the positioning hole to transmit the reflected measurement signal received by the signal transmitter to a wireless receiver disposed in the via.

11. The rotary type distance sensing device as claimed in claim 9, wherein the linking structure can be implemented by a pulley structure, a gear structure, or any other structure which can be driven by the driver to move and to enable the rotating mount to rotate.

12. The rotary type distance sensing device as claimed in claim 9 further comprising a conductive structure having a plurality of power transmitting structures and a power receiving structure, wherein the plurality of power transmitting structures is disposed on the inner wall of the via and is connected with a power supplying device to provide power; the power receiving structure is disposed in the via and goes through the rotating mount to be connected with the control module, thereby receiving the power provided by the power transmitting structure and powering the control module.

13. The rotary type distance sensing device as claimed in claim 12, wherein the power receiving structure comprises at least two annular conductor disposed around the outer rim thereof, each one of the plurality of power transmitting structures comprises at least one positive electrode brush and at least one negative electrode brush being in contact with the at least two annular conductors respectively, wherein the positive electrode brush and the negative electrode brush are each disposed at the inner wall of the via through a spring plate to be in contact with the power supplying device.

14. The rotary type distance sensing device as claimed in claim 12, wherein the power receiving structure is disposed with at least one transmission unit thereon, the rotating mount is disposed with at least one penetrating hole corresponding to the transmission unit, wherein the transmission unit goes through the penetrating hole to be connected with the control module to power the control module.
